(19) United States
(12) Patent Application Publication
(10) Pub. No.: US 2015/0082764 A1
(43) Pub. Date: Mar. 26, 2015

(54) LASER HARDENED KNIFE GUARD

(71) Applicants: Keith A. Johnson, Kewaskum, WI (US); Neal J. Stoffel, Campbellsport, WI (US)

(72) Inventors: Keith A. Johnson, Kewaskum, WI (US); Neal J. Stoffel, Campbellsport, WI (US)

(73) Assignee: Kondex Corporation, Lomira, WI (US)

(21) Appl. No.: 14/038,150

(22) Filed: Sep. 26, 2013

(51) Int. Cl. A01D 34/01; C21D 9/18; C21D 1/09

(52) U.S. Cl. CPC A01D 34/015; C21D 1/09; C21D 9/18
USPC 56/298; 148/565

(57) ABSTRACT

A laser hardened knife guard is provided. In one aspect, the invention provides for a knife guard that comprises a guard body that further comprises a base material. The base material includes a mounting bar that defines at least one bolt hole and at least one tine projecting forward from the mounting bar. The base material has a first hardness. A laser treated material is formed into or in the base material. The laser treated material comprises a second hardness greater than the first hardness.

### FIELD OF THE INVENTION

This invention generally relates to a laser hardened knife guard for a sickle bar assembly.

### BACKGROUND OF THE INVENTION

Knife guards are used in sickle style cutting systems. They act as the stationary surface for moving sickle blades to cut against or at least to protect or cover the sickle blades. Examples are shown in U.S. Pat. Nos. 6,962,040, 4,660,361, 7,478,522, and 8,464,506 the disclosures of which are incorporated by reference as the present invention may be applied and/or incorporated into these examples in various embodiments.

Knife guards are primarily constructed of steel and manufactured in a variety of ways including forging, casting, welded fabrication of stamped components, and machining. In some instances, a hardened plate is assembled into the guard to create a surface known as a ledger plate that the sickle runs on and the edge. Past efforts to improve the hardness of the ledger plate and the edge have included hardening via quench and temper or austemper, carborizing or carbonitriding, induction hardening, flame hardening, or boronizing. In some cases, more than one of these treatments is performed on the part in order to impart varying properties within the knife guard.

With the exception of induction hardening, the remaining treatments are high heat processes of over 1500° F. and require the entire part to be raised into these temperature ranges. The knife guard in its original state contains internal stresses. Accordingly, distortion of the part is a factor with these processes. Distortion is not desirable where the knife guard provides a bearing surface supporting sliding movement and reciprocation of a sickle bar. The result is often additional machining or straightening processes to bring the part back within specification. These additional steps increase cost.

In the case of induction hardening, typically very elaborate induction coils and quenching processes are required to perform the process in a repeatable and predictable manner. Induction heat is a resistance type of heating. The result of this process along with flame hardening a heat affected zone which is driven deep into the part. In order to achieve the desired microstructure in knife guard material, a quench process must be used to reduce the internal temperature of the knife guard quickly enough to create the proper metallurgical transformation. In addition, the induction process focuses the energy in the thinner section of the knife guard edge resulting in the risk of melting the material at the edge. The depth of the heat affected zone also creates a similar situation to the previously mentioned treatments in that it causes stresses in the part to be relieved often resulting in distortion of the part.

### BRIEF SUMMARY OF THE INVENTION

The present invention is generally directed towards laser hardening the knife guard in one or more select regions. Laser hardening may be done to the ledger plate and edges to produce hardened areas on the ledger bar of the knife guard and may be done along edges of the knife guard so as to maintain the sharpness of the edges of the knife guard. These and other advantages of the invention, as well as additional inventive features, will be apparent from the description of the invention provided herein.

In one aspect, the invention provides for a knife guard that comprises a guard body that further comprises a base material. The base material includes a mounting bar that defines at least one bolt hole and at least one tine projecting forward from the mounting bar. The base material has a first hardness. A laser treated material is formed into or in the base material. The laser treated material comprises a second hardness greater than the first hardness.

The knife guard include a ledger surface that is adapted to bear against or at least face a sickle bar assembly. The ledger surface includes a region of laser hardened layer formed integrally with an outer surface of the base material to provide for the laser treated material.

The base material may be steel and the laser hardened layer may be at least 0.5 millimeter in depth thickness along the base material and less than 3 millimeters.

The tines can comprise a central protrusion and a pair of flank surfaces on either side of the protrusion that extend from the bottom surface toward the bearing surface. The flank surfaces intersect the bearing surface at a shearing edge. The region of the laser hardened layer may include at least one portion formed above the flanks along ledger surface that forms part of the shearing edge.

The knife guard may further comprise a free region of base material that is not a laser hardened layer. The free region may be disposed above the central protrusion along the ledger surface and between first and second portions of laser hardened layer. The first and second portions are formed above the flanks along ledger surface and form part of the shearing edge.

An advantage of laser hardening select regions and limited regions leaving free regions is that distortion can be prevented or minimized reducing or eliminating post machining or straightening steps along bearing surfaces.

The knife guard may further include a trash bar. The trash bar extends perpendicularly to an extension direction of the at least one tine. The trash bar connects adjacent tines of the at least one tine. The free region extends along the ledger surface that extends along a trash bar portion of the ledger surface defined by the trash bar. The trash bar is free of the laser hardened layer.

The mounting bar can include a ledger bar that extends perpendicularly to an extension direction of the at least one tine. The ledger bar defines a ledger bar portion of the ledger surface. The ledger bar portion forms part of the region of laser hardened layer along the length thereof.

In one embodiment more than 40% of the ledger surface is free of the region of laser hardened layer. The laser hardened layer may be between 0.5 millimeter and 3 millimeter in depth thickness along the base material at the shearing edge. During erosion of the flank surfaces, the laser hardened layer sharpens into the laser hardened layer.

The at least one portion formed above the flanks along ledger surface that forms part of the shearing edge may be formed in a non-linear oscillation profile to provide a serrated pattern for serrated cutting performance.

In one embodiment over 85% of an outer surface of the knife guard may form an untreated region of base material. The laser treated material may be limited to less than 15% of the outer surface. The base material may have a hardness of less than 50 HRC, and the laser treated material can have a hardness between 50 and 70 HRC and preferably between 50 to 65 HRC. The laser treated material has a hardness at least 5 HRC points higher than the base material and typically 10 HRC points or more higher than the base material.

In another aspect, the invention provides that the knife guard may include at least one tine that comprises a plurality of tines with valleys between the tines. The at least one bolt hole may comprise a plurality of bolt holes. The bolt holes may have respective bolt mounting centers aligned along an mounting axis that extends perpendicularly relative to a forward extending axis direction of the tines. The bolt holes may be formed in mounting bosses formed along the mounting bar. A connecting trashbar may extend perpendicularly relative to the forward extending axis direction and connect adjacent tines. The mounting bar can include a ledger bar. The ledger bar and the tines define a ledger surface that extends in a plane. A sickle clearance channel is formed between the ledger bar and the trash bar. Ribs at a bottom of the sickle clearance channel connect the ledger bar and the trash bar.

The ledger bar may project from a mounting plate portion of the mounting bar. Mounting bosses may be formed into the mounting plate.

In yet another aspect, the invention provides for a cutter bar assembly that can include a linear array of a plurality of the knife guards. The cutter bar assembly can include a cutter bar support having a mounting flange that extends in parallel relation to the linear array. The sickle bar assembly may extend in a longitudinal direction in parallel relation with the cutter bar support in order to reciprocate back and forth in the longitudinal direction for cutting. The sickle bar assembly can include a sickle bar frequently referred to as a knife back and a plurality of sickle knives mounted to the sickle bar. The knife guards may be arranged in side by side relation. The sickle knives may be arranged in side by side relation. The knife guards and sickle knives may be arranged in a vertically overlapping relation wherein the knife guards may be over the sickle knives or wherein the sickle knives may be over the knife guards.

The sickle bar slides along the knife guards along a region of laser hardened layer formed integrally with an outer surface of the base material to provide for the laser treated material.

Another aspect of the present invention is directed toward a method of forming a knife guard. The knife guard can comprise a guard body. The guard body may comprise a base material that includes a mounting bar that defines at least one bolt hole and at least one tine projecting forward from the mounting bar. The method comprises hardening with a laser a region of the base material to provide a second hardness greater than the first hardness.

The hardening with the laser can include using at least one of the following lasers CO2, YAG, Diode and Fiber. The hardening may comprise targeting and confining the application of the laser to the region of an outer surface of the guard body. The region may be less than 20% of an area of the outer surface.

The laser hardening can be conducted without a liquid quenchant. The base material of the guard body operates as a heat sink to allow the part to quench to a hardened microstructure in said region. No further tempering operation is conducted after the hardening with the laser.

The laser hardened region may be formed along a ledger surface that forms a sliding interface with a sickle bar assembly that reciprocates relative to the knife guard in use.

Part of the ledger surface may be free and untreated with the laser with an at least 30% untreated region. Distortion may be eliminated or reduced such that subsequent machining or straightening operations are not conducted on the ledger surface after said hardening. The laser hardened region can be formed along a shearing edge formed along opposing sides of the at least one tine.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1A is a schematic top view of a first portion of a knife guard according to an embodiment of the present invention with the laser hardened regions emphasized.

FIG. 1B is a section view taken about area A in FIG. 1A and illustrating with emphasis the laser hardened regions above the flanks of the knife guard.

FIG. 2 is an isometric view of a knife guard according to an embodiment of the present invention.

FIG. 3 is a side view of the knife guard of FIG. 3.

FIG. 4 is an enlarged side view of the area taken about the sickle clearance channel of the knife guard of FIG. 3.

FIG. 5 is a schematic illustration of at least two portions of knife guards and sickle blades of an embodiment of the present invention, the distance between knife guards being potentially exaggerated (e.g. trash bars of adjacent knife guards my abut or almost abut each other at less than 1 cm in spacing.)

FIG. 6 is a schematic illustration of an embodiment of a knife guard of the present invention with a non-linear oscillation profile showing the laser hardening tool movement and application to the knife guard.

FIG. 7 is a schematic illustration of an embodiment of fabricated knife guard of the present invention with the laser hardening tool angularly positioned to laser treat the ledger and or bearing surfaces of the tines.

FIG. 8 is a schematic illustration of an embodiment of a knife guard of the present invention with the laser hardening tool angularly positioned to laser treat the ledger and or bearing surfaces of the tines.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

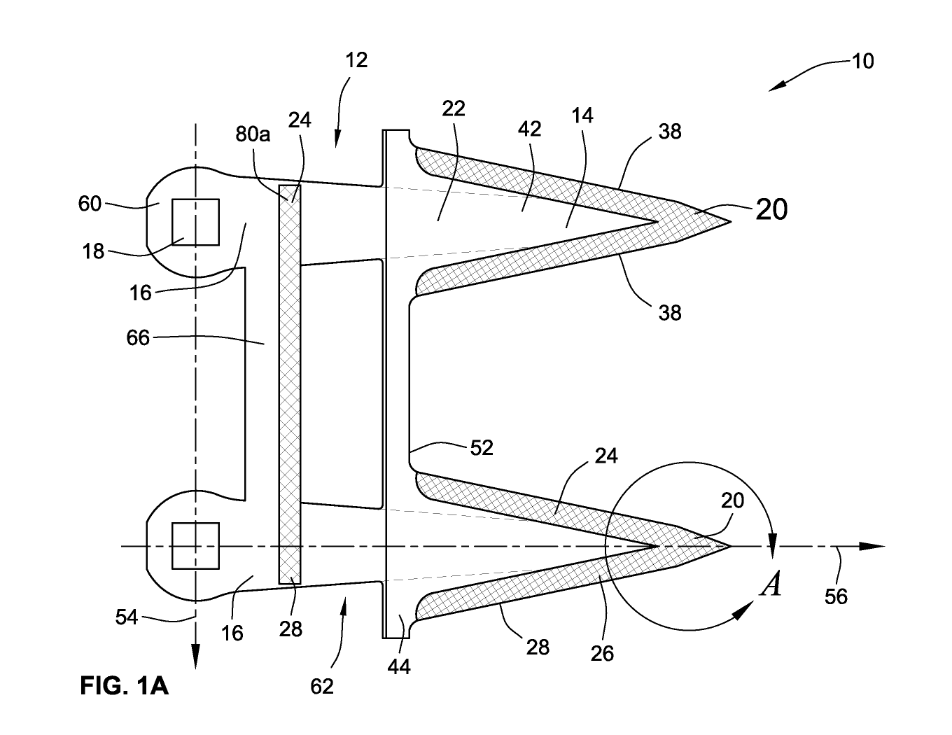

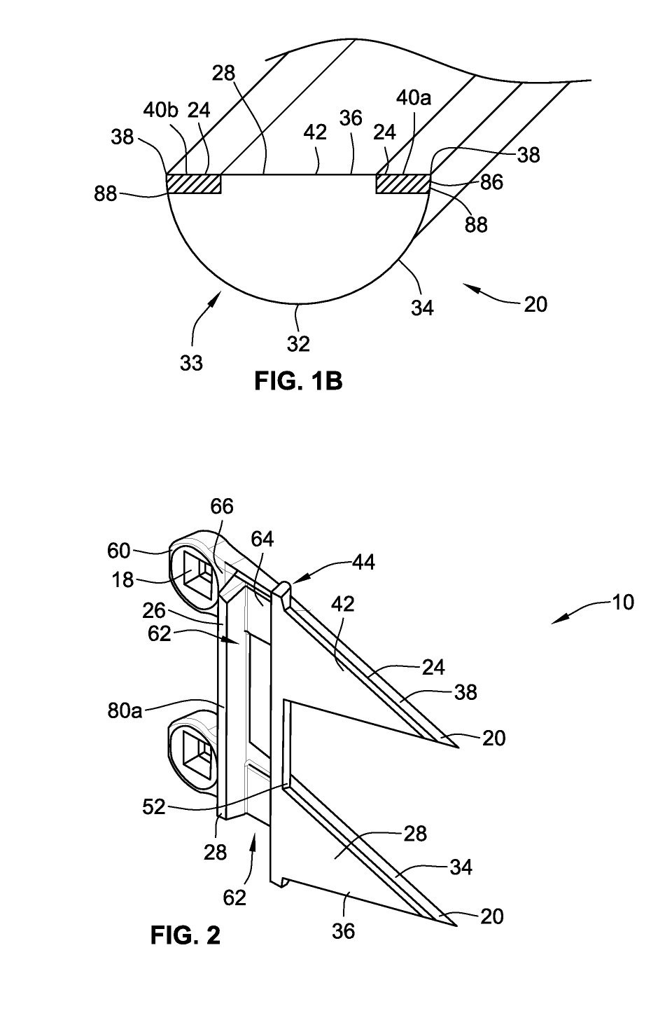

As shown in FIGS. 1A and 1B, a laser hardened knife guard 10 according to an embodiment of the present invention is illustrated. A knife guard 10 comprises a guard body 12 and is comprised of a base material 14 such as steel material, that includes a mounting bar 16, which defines at least one bolt hole 18 and at least one tine 20 projecting forward 56 from the mounting bar 16. The base material 14 has a first hardness 22 and a laser treated material 24 is formed into or in the base material. The laser treated material 24 comprises a second hardness 26, greater than the first hardness 22.

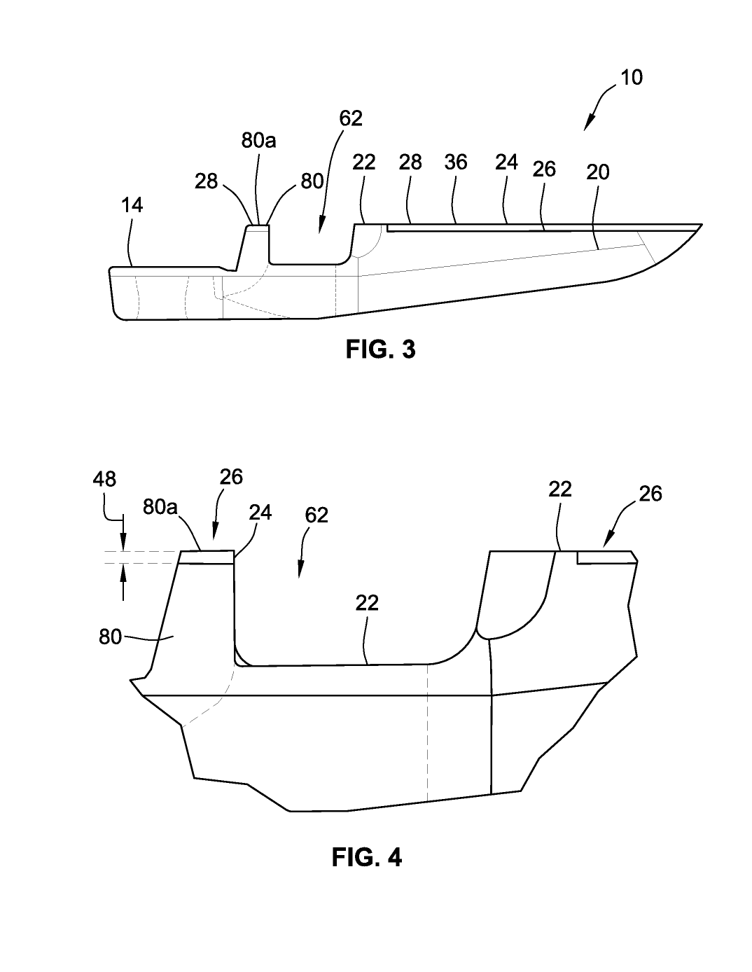

The knife guard 10 includes a ledger surface 28 that is adapted to bear against or at least face a sickle bar assembly 30. Typically the ledger surface 28 will come into contact with the sickle bar assembly 30 to guide or maintain linear reciprocating movement of the sickle bar assembly 30. FIG. 5 illustrates an embodiment of the present invention wherein the sickle bar assembly 30 moves over the ledger surface 28 of a knife guard 10. The ledger surface 28 includes a region of laser hardened layer 26 formed integrally with in outer surface of the base material 14 to provide for the laser treated material 26. As shown in FIG. 3 the ledger surface 28 may be provided by respective coplanar regions of ledger bar portion 80a and bearing surface portion 36 of the of tines 20.

The base material 14 may be steel and the laser hardened layer 26 is at least 0.5 millimeters and less than 3 millimeters in depth thickness 48 along the base of the material.

FIG. 1B illustrates a tine 20 comprising a bottom surface 33 that includes a central protrusion 32 and a pair of flank surfaces 34 on either side of the central protrusion 32 extending toward a bearing surface 36. A portion of the flank 34 that extends toward the bearing surface 36 acts as a cutting support surface 86. The cutting support surfaces 86 of the flank surfaces 34 intersect the bearing surface 36 at a shearing edge 38. The region of laser hardened layer 26 includes at least one portion 48 formed above the flanks along the ledger surface 28 and along the cutting support surfaces 86 and forms part of the shearing edge 38.

FIG. 1B illustrates an angle of 90° between the laser hardened bearing surface portion 36 and the cutting support surface 86 of the flanks 34. For the system to perform at an optimum level, the guard 10 should preferably maintain a sharp corner between the ledger face 28 that the sickle blades 78 that run on the cutting support surface 86. Often, the cutting support surface 86 of each tine 20 is undercut in order to allow for an angle between these two surfaces of less than 90 degrees as shown for example in FIG. 2 about the area of character reference 24. Thus the cutting support surface 86 may be a beveled edge under the shearing edge 38 running generally from the tip of the tine to the start of the trash bar 44, or in those embodiments wherein there is no trash bar 44, to the end of the tine's bearing surface 36.

The knife guard 10 may further comprise a free region 42 of base material 14 that is not a laser hardened layer. As illustrated in FIG. 1B, the free region 42 may be disposed under the central protrusion 32 along the bearing surface portion 36 and between first and second portions 40a, 40b of a laser hardened layer 26. The first and second portions 40a, 40b being formed along the bearing surface portion of the ledger surface 28 and cutting support surfaces 86 and includes the shearing edges 38. The free region 42 can limit distortion and cost associated with laser hardening operations.

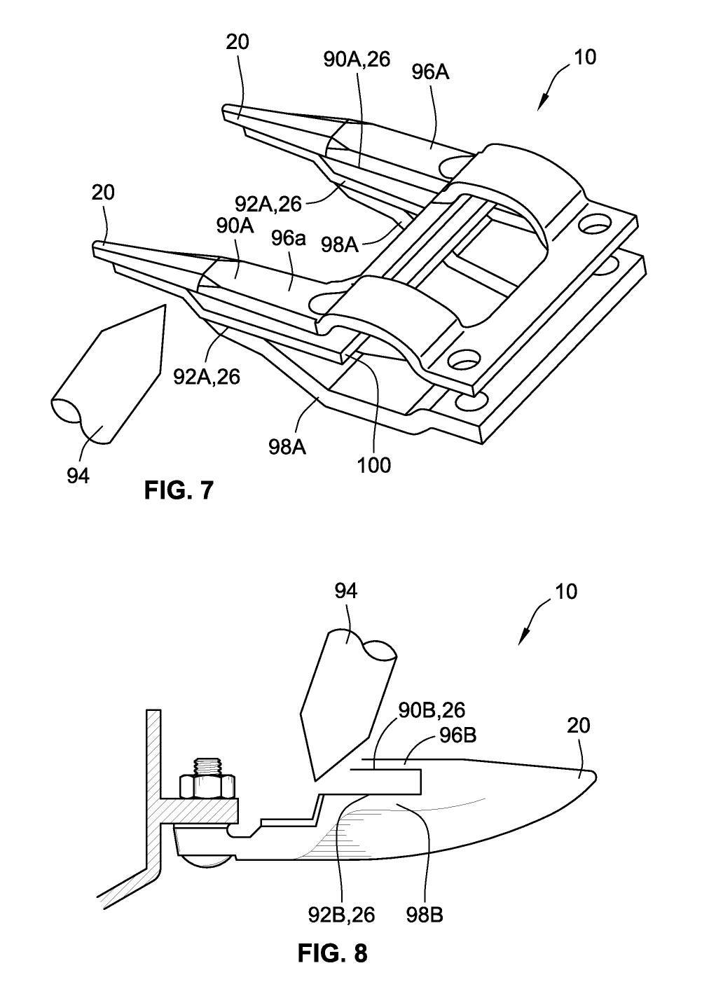

FIG. 2 illustrates that the knife guard 10 may further comprise a trash bar 44 that extends perpendicularly to an extension direction 56 of the at least one tine 20 and connecting adjacent tines of the at least one tine 20. The free region 42 may extend along the bearing surface portion 36 of ledger's surface 28 that extends along trash bar 44. The trash bar 44 may be free of the laser hardened layer 26. All (90% or more) of the ledger bar portion 80a may be heat treated while half or more of the bearing surface portion 36 may be laser heat treated. As can be readily appreciated not every embodiment of tine 10 has a trash bar 44 with associated ledger portion 80a. For example, as shown in FIG. 7 tine 10 does not have a trash bar, and this embodiment may be configured without the trash bar.

The mounting bar 16 includes a ledger bar 80 that extends perpendicularly to an extension direction 56 of the at least one tine 20. The ledger bar 80 defines a ledger bar portion 80a of the ledger surface 28 wherein the ledger bar portion 80a forms part of the region of laser hardened layer 26 along the length thereof. More than 30% of the overall ledger surface 28 may be free of the region of laser hardened layer 26. As illustrated in FIG. 7 not every embodiment of a laser treated guard has a ledger bar and thus would not have a ledger bar portion 80a that would be part of the laser hardened layer 26 or form part of ledger surface 28.

The laser hardened layer 26 may be between 0.5 millimeter and 3 millimeter in depth thickness 48 along the base material 14 at the shearing edge 38. During erosion of the flank surfaces 34 of the untreated base material 14, the cutting support surface 86 that is part of the laser hardened layer 26 may be sharpened along its lower edge 88 relative to bearing surface 36. This self-sharpening effect may result from the erosion of the softer base material 14 above the hardened zone 24, 26 (as shown for example in FIG. 1B) along the flanks 34 due to the interaction with the crop material during the cutting motion and in conjunction with the forward motion of the unit through the field. The erosion of the softer based material 14 along the flanks 34 exposes the harder edges 38, 88 of the cutting support surfaces 86 allowing them to protrude and thus maintaining the shearing edges 38, 88.

The laser hardening process, due to its fast interaction with the material, can produce compressive stresses at the surface of the heat treated zone, which increases the fatigue properties of the part in certain cases.

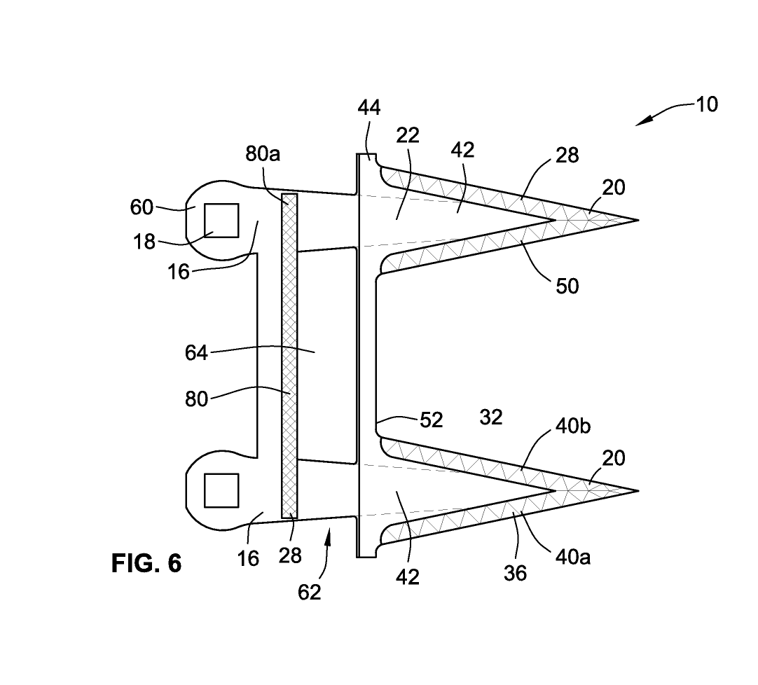

The laser hardened portions 40a and 40b formed above the flanks 34 along the ledger surface 28 that forms part of the shearing edge 38 may be formed in a non-linear oscillation profile 50 (which indicates the laser tool application path) that provides for a serrated pattern for serrating cutting performance as shown in FIG. 6. As erosion of the softer base material 14 occurs during operation of the knife guard 10 the serrated pattern along the cutting support surfaces 86 of the flanks 34 and the bearing surface 36 results in self-sharpening of the serrated cutting edges 38, 88.

Over 85% of the outer surface of the knife guard 10 may form an untreated region of base material 14. The laser treated material 24 may be limited to less than 15% of the outer surface of the knife guard 10 and as shown, formed preferably only along the ledger surface 28. The base material 14 may have a hardness of less than 50 HRC and the laser treated material 24 may have a hardness between 50 and 70 HRC, less than 50 HRC, and the laser treated material can have a hardness between 50 and 70 HRC and preferably between 50 to 65 HRC. The laser treated material has a hardness at least 5 HRC points higher than the base material and typically 10 HRC points or more higher than the base material.

The at least one tine 20 may comprise plurality of tines 20 with, as shown for example in FIG. 6, valleys 52 between the tines. The at least one bolt hole 18 may comprise a plurality of bolt holes 18 having respective bolt hole mounting centers aligned along a mounting axis 54, as shown if FIG. 1A, that extends perpendicularly relative to a forward extending axis direction 56 of the tines 20. The bolt holes 18 may be formed in mounting bosses 60 formed along the mounting bar 16. A connection trash bar 44 extends perpendicularly relative to the forward extending axis direction 56 and connecting adjacent tines 20. The mounting bar 16 includes a ledger bar 80. The ledger bar 80 and the tines 20 define a ledger surface 28 that extends in a plane wherein a sickle clearance channel 62 is formed between the ledger bar 80 and the trash bar 44. Ribs 64 at a bottom of the sickle clearance channel 62 connect the ledger bar 80 and the trash bar 44. The ledger bar 80 projects from a mounting plate portion 66 of the mounting bar 16. The mounting bosses 60 are formed into the mounting plate 66.

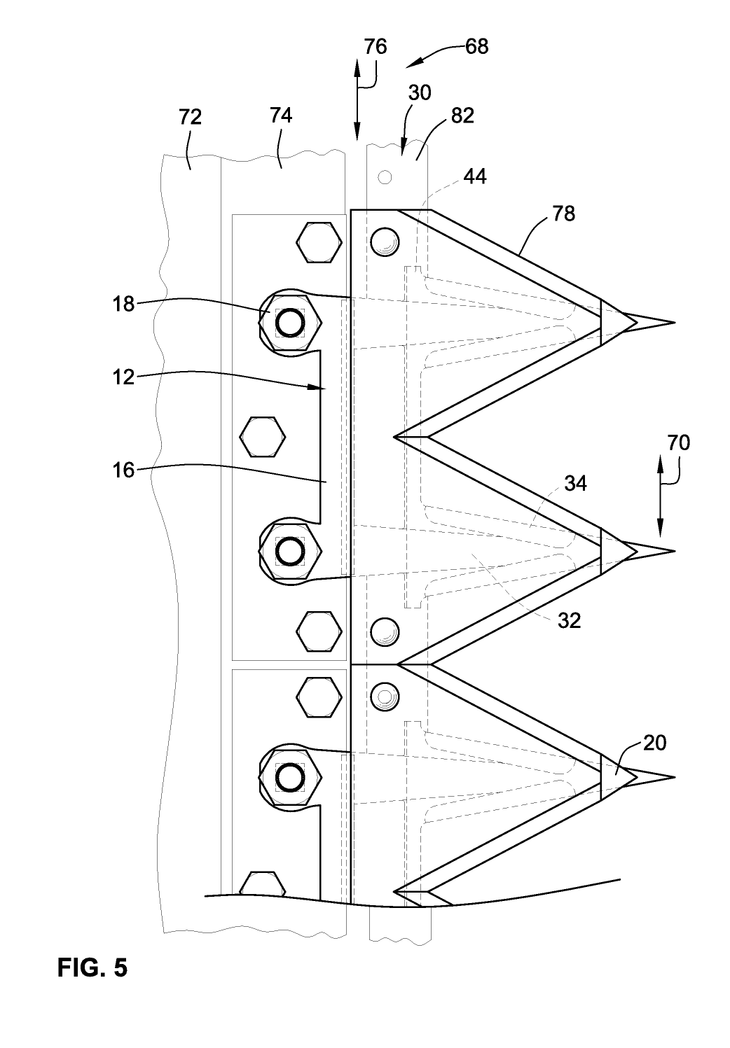

FIGS. 3 and 4 show in greater detail the ledger surface 28 comprising the ledger bar portion 80a and the bearing surface 36 of a tine 20. The ledger bar portion 80a of ledger bar 80 may be of laser treated material 24 forming a second hardness 26 relative to the base material 14 of a first hardness 22. Further illustrated is the depth thickness 48 of the laser treated material 24 on both the ledger bar 80 and the flank surface 34 of the tine 20. The free region 42 is the region that has not been laser treated and remains of the first hardness 22 of the base material 14.

FIG. 5 illustrates a cutter bar assembly 68 that includes a linear array of a plurality of knife guards 10 of an embodiment of the present invention. A cutter bar support 72 has a mounting flange 74 that extends in parallel relation to the linear array of knife guards. A sickle bar assembly 30 extends in a longitudinal direction 70 and parallel relation with a cutter bar support 72 in order to reciprocate back and forth in a longitudinal direction 70 for cutting. The sickle bar assembly 30 includes a sickle bar also commonly referred to in the art as a knife back 82 and a plurality of sickle knives 78 mounted to the sickle bar 82. The sickle knives 78 are arranged in side by side relation. The knife guards 10 are arranged in side-by-side relation. The sickle knives 78 are in a vertically overlapping relation to the knife guards 10. A portion of the sickle bar 82 rides inside the sickle clearance channel 62 while a surface of each of the sickle knives 78 rides over the ledger surface 28 of the knife guards 10.

An embodiment of the present invention showing two portions of tines 20 is shown in FIG. 5. The trash bar 44 of each portion of tines 20 as shown here meets the next portion with no overlap. However, as can be readily appreciated, the tines may be mounted such that the trash bar 44 of one portion may overlap the trash bar 44 of a second portion. As can be readily appreciated not every embodiment of knife guard has a trash bar or ledger bar and yet other embodiments as shown in FIG. 7 have a retainer portion over a base portion of the tine either portion or both of which may be laser treated with an angular approach of the laser tool as depicted in FIGS. 7 and 8. Thus about the edges and along the bearing surfaces on either side of the tines and on either or both the cover and the bottom a laser hardened area is formed just as in the other embodiments heretofore described.

The laser used to harden the base material 14 may include using at least one of the following lasers; CO2, YAG, Diode and fiber. The laser beam consists of a column of light energy of similar wave length. These different types of lasers produce different wave lengths of light. These lasers each have their own unique characteristics, but all work well in heat treating applications.

The laser hardening of the knife guard 10 results in a hardened area along the edge of the guard 10 necessary to maintain the sharpness of the edge 38 defined by the hardened portion of the ledger surface portions 40a and 40b and the cutting supports surfaces 86. The method of using the laser to laser harden the knife guard 10 has the advantage over other processes currently in use of involving a smaller heat effected zone that is created with the laser. The smaller heat affected zone results in less distortion of the part and minimal disruption to the microstructure of the base part, which allows better material properties in the base part after laser hardening. In some cases, it is desirable to heat treat the base part to a lower hardness to allow for a mixture of strength and toughness. This lower heat effected zone maintains the prior heat treatment and a greater percentage of the base part will compare to induction or flame hardening.

The lower distortion eliminates subsequent machining and/or straightening operations, thus reducing processing time and costs. The process of heat treating the base material 14 for strength and toughness, then machining the surface (if necessary) for the section to ride on, then laser hardening can be performed easily. This process of hardening the edge after heat treat is difficult to perform without distortion or the risk of melting the edge material.

However, with the laser hardening process, the body of the part acts as a heat sink to allow the part to quench to the proper microstructure. With other heat treatment processes, the part must be submerged in a quench (oil, air, water, polymer solution, molten salt, etc.) The rapid quenching by submersion results in a rapid transformation of the part, which can impart internal stresses causing distortion. Oftentimes with other heat treatment processes, a secondary tempering process is necessary to relieve these internal stresses, thus adding another opportunity for the part to deform along with adding additional process steps and costs.

FIG. 6 illustrates that the precision of the laser heat treatment zone and the precision of the laser motion system allows for non-linear heat treat patterns 50 that would enhance the performance of the part. An oscillation profile 50 would result in the part eroding in a serrated pattern 50, which would improve cutting performance. Thus, the precision of the laser heat treat zone and precision of the laser motion system allows the heat treatment to be applied in specific areas, which allows for other critical structures in the knife guard 10 to perform as designed with different material properties.

FIG. 7 illustrates a fabricated embodiment of a laser hardened knife guard 10 of the present invention. The knife guard 10 of this embodiment does not have a ledger bar or a trash bar. The knife guard 10 is comprised of two tines 20 with each tine 20 further comprised of a retainer portion 96A and a base portion 98A. The bottom surface 90A of the retainer portion 96A of each tine 20 acts as a bearing surface under which passes a sickle blade 100. The two edges of the bottom surface 90A of the retainer portion 96A act as cutting edges against the knife blade 100 and may be beveled and or serrated.

Still with reference to FIG. 7, the top surface 92A of each base portion 98A of each tine 20 acts as and provides a bearing surface for the sickle blade 100. The two edges of the top surface 92A of the base portion 98A act as cutting edges against the knife blade 100 and may be beveled or serrated.

A laser tool 94 makes an angular approach to laser harden along the length of the bearing surfaces 90A, 92A of the retainer portion 96A and base portion 98A from the cutting edges inwardly towards the center of the bearing surfaces 90A, 92A. Thus, in this two tine 20 embodiment there are eight cutting edges and thus eight portions of laser hardened areas on the bearing surfaces 90A, 92A extending from the cutting edges thereof. It can be readily appreciated as with the previous embodiments only a portion of the bearing surfaces are laser hardened along the cutting edges in order to obtain the same advantages heretofore discussed in the other embodiments, for example, self-sharpening of the cutting edges and decreased wear of the bearing surfaces 90A, 92A of the knife guard 10.

FIG. 8 illustrates yet another embodiment of a laser hardened knife guard 10 of the present invention. As with FIG. 7 the tine 20 of this embodiment has a retainer portion 96B and a base portion 98B. The bottom surface 90B of the retainer portion 96B acts as a bearing surface for a knife blade and thus with an angular approach of the laser tool 94 laser hardening may be accomplished on the bearing surface 90B along the edges thereof. Further, the top surface 92B of the base section 98B acts as a bearing surface for the knife blade 100 and thus with an angular approach of the laser tool 94, laser hardening may be accomplished on the bearing surface 92B along the edges thereof for all the same advantages heretofore discussed.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A knife guard, comprising:
a guard body comprising a base material including a mounting bar defining at least one bolt hole and at least one tine projecting forward from the mounting bar, the base material having a first hardness; and
a laser treated material formed into or in the base material, the laser treated material comprising a second hardness greater than the first hardness.

2. The knife guard of claim 1, wherein knife guard includes a ledger surface that is adapted to bear against or at least face a sickle bar assembly, the ledger surface including a region of laser hardened layer formed integrally with an outer surface of the base material to provide for the laser treated material.

3. The knife guard of claim 2, wherein the base material is steel, wherein the laser hardened layer is at least 0.5 millimeter in depth thickness along the base material, and less than 3 millimeters.

4. The knife guard as in claim 2, wherein each of the tines comprises a central protrusion and a pair of flank surfaces on either side of the central protrusion extending toward a bearing surface, the flank surfaces intersecting the bearing surface at a shearing edge, the region of laser hardened layer including at least one portion formed above the flanks along ledger surface and forming part of the shearing edge.

5. The knife guard of claim 4, further comprising a free region of base material that is not of the laser hardened layer, the free region being disposed above the central protrusion along the ledger surface and between first and second portions of laser hardened layer, the first and second portions being formed above the flanks along ledger surface and forming part of the shearing edge.

6. The knife guard of claim 5, further comprising a trash bar extending perpendicularly to an extension direction of the at least one tine and connecting adjacent tines of the at least one tine, the free region extending along the ledger surface extending along a trash bar portion of the ledger surface defined by the trash bar, wherein the trash bar is free of the laser hardened layer.

7. The knife guard of claim 2, wherein the mounting bar includes a ledger bar extending perpendicularly to an extension direction of the at least one tine, the ledger bar defining a ledger bar portion of the ledger surface, wherein the ledger bar portion forms part of the region of laser hardened layer along the length thereof.

8. The knife guard of claim 2, wherein more than 30% of the ledger surface is free of the region of laser hardened layer.

9. The knife guard of claim 4, wherein the laser hardened layer between 0.5 millimeter and 3 millimeter in depth thickness along the base material at the shearing edge, wherein during erosion of the flank surfaces, the laser hardened layer sharpens into the laser hardened layer.

10. The knife guard of claim 9, wherein the at least one portion formed above the flanks along ledger surface and forming part of the shearing edge is formed in a non-linear oscillation profile to provide a serrated pattern for serrated cutting performance.

11. The knife guard of claim 1, wherein over 85% of an outer surface of the knife guard forms an untreated region of base material, the laser treated material being limited to less than 15% of the outer surface.

12. The knife guard of claim 1, wherein the base material has a hardness of less than 50 HRC, and wherein the laser treated material has a hardness between 50 and 70 HRC.

13. The knife guard of claim 1, wherein the at least one tine comprises a plurality of tines with valleys between the tines, the at least one bolt hole comprises a plurality of bolt holes having respective bolt mounting centers aligned along a mounting axis that extends perpendicularly relative to a forward extending axis direction of the tines, the bolt holes being formed in mounting bosses formed along the mounting bar, a connecting trashbar extending perpendicularly relative to the forward extending axis direction and connecting adjacent tines, the mounting bar including a ledger bar, the ledger bar and the tines defining a ledger surface extending in a plane, wherein a sickle clearance channel is formed between the ledger bar and the trash bar, ribs at a bottom of the sickle clearance channel connecting the ledger bar and the trash bar.

14. The knife guard of claim 13, wherein the ledger bar projections from a mounting plate portion of the mounting bar, the mounting bosses formed into the mounting plate.

15. A cutter bar assembly including a linear array of a plurality of knife guards including the knife guard of claim 1, the cutter bar assembly comprising:
a cutter bar support having a mounting flange extending in parallel relation to the linear array;
a sickle bar assembly extending in a longitudinal direction in parallel relation with the cutter bar support in order to reciprocate back and forth in the longitudinal direction for cutting, the sickle bar assembly including a sickle bar and a plurality of sickle knives mounted to the sickle bar,
the knife guards are arranged in side by side relation,
the sickle knives are arranged in side by side relation; and
wherein the knife guards and the sickle knives are in vertically overlapping relation.

16. The cutter bar assembly of claim 15, wherein the sickle bar slides along the knife guards along a region of laser hardened layer formed integrally with an outer surface of the base material to provide for the laser treated material.

17. A method of forming a knife guard, the knife guard comprising a guard body, the guard body comprising a base material including a mounting bar defining at least one bolt hole and at least one tine projecting forward from the mounting bar, the method comprising:
hardening with a laser a region of the base material to provide a second hardness greater than the first hardness.

18. The method of claim 1, wherein said hardening with the laser includes using at least one of the following lasers CO₂, YAG, Diode and Fiber.

19. The method of claim 1, wherein the hardening comprises targeting and confining application of the laser to the region being of an outer surface of the guard body, the region being less than 20% of an area of the outer surface.

20. The method of claim 19, wherein the laser hardening is conducted without a liquid quenchant, wherein the base material of the guard body operates as a heat sink to allow the part to quench to a hardened microstructure in said region.

21. The method of claim 20, wherein no further tempering operation is conducted after the hardening with the laser.

22. The method of claim 19, wherein said region is formed along a ledger surface that forms a sliding interface with a sickle bar assembly that reciprocates relative the knife guard in use.

23. The method of claim 22, wherein part of the ledger surface is free and untreated with the laser with an at least 30% untreated region, and wherein distortion is eliminated or reduced such that subsequent machining or straightening operations are not conducted on the ledger surface after said hardening.

24. The method of claim 17, wherein the region is formed along a shearing edge formed along opposing sides of the at least one tine.
